(19) United States
(12) Patent Application Publication
(10) Pub. No.: US 2018/0285309 A1
(43) Pub. Date: Oct. 4, 2018

(54) DATA BUS MESSAGE FILTER

(71) Applicant: Government of the United States, as represented by the Secretary of the Air Force, Wright-Patterson AFB, OH (US)

(72) Inventor: David C. Prentice, Springboro, OH (US)

(21) Appl. No.: 15/729,883

(22) Filed: Oct. 11, 2017

Related U.S. Application Data
(60) Provisional application No. 62/478,809, filed on Mar. 30, 2017.

(51) Int. Cl. G06F 13/42; G06F 13/40

(52) U.S. Cl. CPC G06F 13/4286; G06F 13/4072; G06F 13/4022

(57) ABSTRACT

A system having a bus controller, a remote terminal, and a message filter, with the message filter having a first transceiver, a second transceiver, and a message processor. The first transceiver is electrically coupled to the bus controller by a first data bus. The second transceiver is electrically coupled to the remote terminal by a second data bus. The message processor is configured to: receive a message from the first transceiver, the message comprising a command word, begin transmission of the message by the second transceiver, extract a destination address from the command word, and stop the transmission of the message when the destination address does not match at least one determined destination address.

### CROSS REFERENCE TO RELATED APPLICATIONS

This application claims the benefit of and priority to U.S. Provisional Application Ser. No. 62/478,809, entitled “Data Bus Message Filter,” filed on Mar. 30, 2017, the entirety of which is incorporated by reference herein.

### STATEMENT OF GOVERNMENT INTEREST

The invention described herein may be manufactured, used and licensed by or for the Government of the United States for all governmental purposes without the payment of any royalty.

### FIELD OF THE INVENTION

The present disclosure relates generally to data bus communications and, more particularly, to management of communications between terminal devices on a data bus.

### BACKGROUND OF THE INVENTION

Many data busses may be subject to unwanted monitoring and/or attack. Data busses may be employed in a variety of communications systems, such as Supervisory Data Acquisition (SCADA) systems and avionics systems. Serial data busses, for example, typically operate in accordance with a pre-determined communication standard, such as MIL-STD-1553 (MIL-STD-1773) for military avionics and ARINC 629 for commercial avionics, to facilitate communications between communication devices or subsystems connected to the bus. In the case of the MIL-STD-1553 communication standard, for example, the data bus facilitates communications between a Bus Controller (BC), a Bus Monitor (BM), and one or more Remote Terminals (RTs) all connected to the bus. RTs are communication devices or subsystems capable of transmitting and/or receiving data over the MIL-STD-1553 data bus. A standalone RT coupled to the data bus may in turn be in communication with one or more subsystems; in this manner, a RT may provide an interface between the data bus and an attached subsystem. Alternately, subsystems having an embedded RT may be directly connected to the MIL-STD-1553 data bus. A MIL-STD-1553 serial data bus that employs optical rather than electrical cabling is often referred to as a MIL-STD-1773 data bus.

Of concern is maintaining the integrity of data bus communications. Receipt of bus messages on a data bus by communication device(s) for whom the messages are not intended may create problems. Further complicating these concerns is the presence of communication devices or subsystems on the data bus that may be changed in and out of the communication system as needed. These communication elements, referred to as line replacement units (LRUs), provide an opportunity for the introduction of security concerns.

### BRIEF SUMMARY OF THE INVENTION

The foregoing problems and other shortcomings, drawbacks, and challenges associated with communications between communication devices or subsystems of a data bus are overcome by the embodiments described herein. While the invention will be described in connection with certain embodiments, it is understood that it is not limited to these embodiments. To the contrary, the present invention includes all alternatives, modifications and equivalents within the scope of the embodiments disclosed.

Therefore, in accordance with an embodiment of the present disclosure, a device is provided. The device may include a first transceiver electrically coupled to a first data bus; a second transceiver electrically coupled to a second data bus; and a message processor. The message processor is configured to receive a message from the first transceiver on the first data bus, the message having a command word; begin transmission of the message by the second transceiver on the second data bus; extract a destination address from the command word; and stop the transmission of the message if the destination address does not match at least one determined destination address.

According to another embodiment, a method is provided. The method may include receiving a message from a first data bus, the message having a command word; starting transmission of the message on a second data bus; extracting a destination address from the command word; and stopping the transmission of the message if the destination address does not match at least one determined destination address.

In still another embodiment, a system is provided. The system includes a bus controller, a remote terminal, and a message filter having a first transceiver electrically coupled to the bus controller by a first data bus; a second transceiver electrically coupled to the remote terminal by a second data bus; and a message processor. The message processor may be configured to: receive a message from the first transceiver, the message having a command word; begin transmission of the message by the second transceiver; extract a destination address from the command word; and stop the transmission of the message if the destination address does not match at least one determined destination address.

Additional objects, advantages and novel features of the invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings provide visual representations which will be used to more fully describe various representative embodiments. They can be used by those skilled in the art to better understand the representative embodiments disclosed and their inherent advantages. The drawings are not necessarily to scale, emphasis instead being placed upon illustrating the principles of the devices, systems, and methods described herein. In these drawings, like reference numerals may identify corresponding elements.

FIG. 1 is a block diagram of an example system employing a message filtering device, in accordance with an embodiment of the present disclosure.

FIG. 2 is a block diagram of an example system employing a MIL-STD-1553 data bus.

FIG. 3 is a table showing example pinouts for interfacing an example bus transceiver circuit(s) to an example field-programmable gate array (FPGA) circuit board, in accordance with an embodiment of the present disclosure.

FIG. 4 is a flow diagram illustrating an example method, in accordance with an embodiment of the present disclosure.

FIG. 5 is a diagram illustrating an example message packet header, in accordance with an embodiment of the present disclosure.

FIG. 6 is an example plot of a signal(s) on the shared data bus with the bus controller (BC) attempting to communicate with two remote terminal units (RTs), in accordance with an embodiment of the present disclosure.

FIG. 7 is an example flow diagram, in accordance with an embodiment of the present disclosure.

### DETAILED DESCRIPTION OF THE INVENTION

The various methods, systems, apparatus, and devices described herein generally provide for improved data bus communications on a data bus. Embodiments of the present disclosure are directed to devices, systems and methods configured to filter messages between two data busses. The filtering may be configured to prevent messages from being received in their entirety by unauthorized communication devices or subsystems on the data bus as well as to prevent unauthorized communication devices from transmitting on the data bus. Selection of a message processor having sufficient processing speed allows for data bus filtering to be performed in conformance with data bus protocol requirements and for starting and then stopping, if required, transmission of a message to unauthorized or unintended communications devices. The resultant inchoate message that was partially transmitted is not fully received by unauthorized devices. This approach, in which the filtering device allows bits of a message to flow through a processor and to a remote terminal (RT) before fully decoding the message, is particularly advantageous for communication protocols that have stringent timing requirements.

The filtering device may be configured to reside between, for example, a first RT on a first data bus and a BC and/or one or more second RTs on a second data bus. In this location, the device may filter messages between the first data bus and the second data bus to protect the first RT from unauthorized or potentially malicious activity. The filtering device may receive messages on a first bus, start transmission of the message on the second data bus, and terminate the transmission as soon as it concludes that the message is addressed to an unapproved destination, effectively ensuring that only a partial transmission of a message, and not the full message itself, is received by an unauthorized RT. The filtering device may also inhibit an unauthorized terminal device from transmitting messages onto a shared data bus, to which one or more RTs are coupled.

According to an embodiment, the device may partially decode messages between a BC and RT using internal electronics. This information may be employed to control the flow of communications traffic to and from the RT by manipulating, for example, a transceiver's receive (RX) enable and/or transmit (TX) inhibit controls. When the device is waiting for BC message(s), the device may also, according to some embodiments, inhibit RT(s) from transmitting on a bus unless they are requested to do so by a BC. To operate the internal electronics, the device may employ external power obtained from an external power source. In some embodiments, power may be provided by way of contacts on a connector. The connector may also include contacts for other purposes, such as, for example, supporting one or more data busses.

While this invention is susceptible of being embodied in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals may be used to describe the same, similar or corresponding parts in the several views of the drawings.

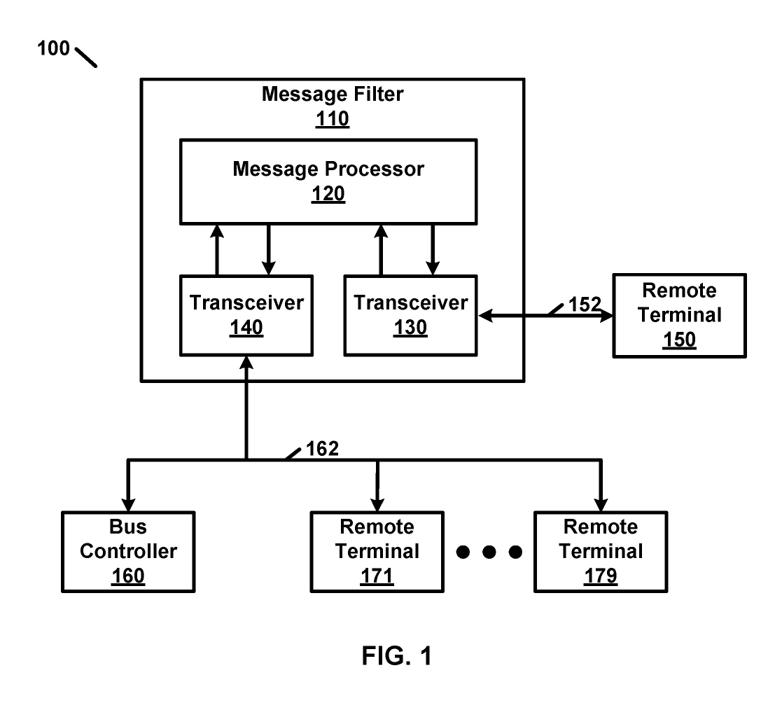

Referring now to the drawings, FIG. 1 is a block diagram of an example system 100 employing a message filtering device 110, in accordance with an embodiment of the present disclosure. The system may have a bus controller (BC) 160, a remote terminal (RT) 150, and a message filter 110. Message filter 110 may be configured to operate so that messages from BC 160 (on shared data bus 162) are passed to RT 150 (on data bus 152) only if the messages are addressed to RT 150. For example, message filter 110 can ensure that a message addressed to and thus intended for RT 179 is not fully received by RT 150. Rather, the message may only be received by RT 179. As a secondary benefit, some of the various embodiments may prohibit RTs (e.g., RT 171 and RT 179) from transmitting onto the shared data bus 162 when they are not requested to do so by BC 160. As used in connection with MIL-STD-1553 embodiments, a message may consist of one or more 16-bit words (command, data, or status) where the words within the message are transmitted contiguously with at least a 4 microsecond gap between messages. Example message configurations for MIL-STD-1553 are described below.

This capability may be employed to protect avionics systems from unexpected bus communications by communication devices or subsystems, particularly RTs that are LRUs. Such communications could indicate that a LRU is faulty, has been compromised, or is unreliable for some reason. Filtering messages on a data bus may hinder or prevent an LRU from performing tasks that are unauthorized or inconsistent with reliable operation, such as transmitting erroneous messages to a BC or other RTs. Such functionality could mitigate the ability of an LRU to monitor the data bus or to cause contention on the data bus by transmitting unauthorized messages on the data bus.

Message filter 110 may have a first transceiver 140, a second transceiver 130, and a message processor 120. The first transceiver 140 may be electrically coupled to a first data bus 162. As shown in this example, data bus 162 is a shared data bus to which multiple RTs 171 and 179 are connected. The second transceiver 130 may be electrically coupled to a second data bus 152. The second data bus 152 may be configured to electrically couple to RT 150.

According to an embodiment, at least one of the first data bus 162 and the second data bus 152 may be a MIL-STD-1553 data bus. MIL-STD-1553 is a military standard published by the United States Department of Defense that defines the mechanical, electrical, and functional characteristics of a serial data bus. MIL-STD-1553 may be employed, for example, as an avionic data bus for use with aircraft avionics and spacecraft on-board data handling (OBDH) subsystems. MIL-STD-1553 features multiple (commonly dual) redundant balanced line physical layers, a (differential) network interface, time division multiplexing, half-duplex command/response protocol, and may handle up to 30 RTs on a shared data bus. A version of MIL-STD-1553 using optical cabling in place of electrical cabling is known as MIL-STD-1773. Either standard can be accommodated in accordance with the disclosed embodiments.

In an embodiment directed to a MIL-STD-1553 data bus, at least one of the first data bus 162 and the second data bus 152 may employ differential signaling. Differential signaling provides for electrically transmitting information using two complementary signals. The technique sends the same electrical signal as a differential pair of signals, each on its own conductor. The pair of conductors may be wires (typically twisted together) or traces on a circuit board. The receiving circuit may respond to the electrical difference between the two signals, rather than the difference between a single wire and ground. An opposite technique, employable by an alternative embodiment, is called single-ended signaling. The embodiments described herein are also compatible with single-ended signaling.

The message processor 120 may be configured to receive a message from the first transceiver 140. As previously described, a message may be one or more bit words that provide information about commands (transmit and receive), data, and status. On a data bus, the state of the bit may typically be either 1 or 0, which may be represented by some distinct state of the data link. The message processor 120 of filter 110 may begin transmission of the message by the second transceiver 130 even before it is known whether a destination address is valid. Thus, after starting transmission, the message processor 120 may extract a destination address from the command word. The message processor 120 may stop the transmission of the message when the destination address does not match at least one determined destination address value (sometimes referred to herein as a determined destination address).

In the case of a MIL-STD-1553 data bus, each of the plurality of bits may be approximately 1 microsecond in duration as defined in the MIL-STD-1553 specification. It is envisioned that the timing of a data bit may vary, depending on the data bus and system specification being employed. In a communication where data is sent bit-serially (one bit followed in time by another, and so on), the distinction of which bit is on the line at any given moment may be defined, at least in part, by time. Asynchronous communication may employ fixed bit times, so the receiver may count time since the start of a message to know what bit is on the line as the stream of bits is received. Bit times are commonly measured in milliseconds, microseconds, or smaller units of time. It is envisioned that a variety of bit times can be accommodated by the embodiments of the disclosure.

In accordance with certain embodiments, communication on the data bus is initiated by BC 160 and starts with a message command word that provides a definition of the message format of the message to be transmitted. The command word contains information about which RT(s) is to respond or listen to the message. If the command word is a receive command word, the RT identified in the command word is to listen; if the command word is a transmit command word, the identified RT should transmit data to the BC. Accordingly, the MIL-STD-1553 standard, for example, has 16-bit receive command words and 16-bit transmit command words sent by the BC to a specific RT, or between the BC and a pair of RTs.

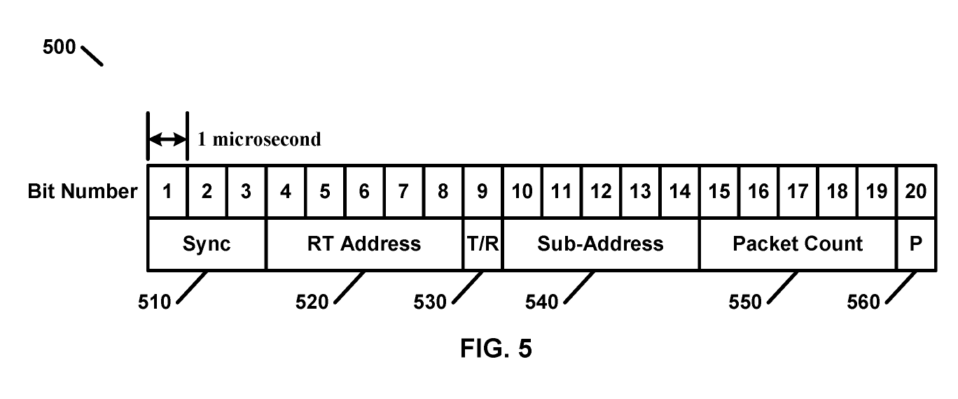

As shown in FIG. 5 and more fully described below, the command word may follow a sequence of synchronization bits, for example, at least three synchronization bits. Synchronization bits may be a sequence of distinctive bits that may be distinguished from data bits by a system to identify the beginning of a message. This may permit the data bits within a message frame to be extracted for decoding and/or retransmission.

The command word may include at least one of a parity field. A parity bit may act as a check on a set of binary values, calculated such that the number of l's in the set plus the parity bit may always be even (or alternately, may always be odd). The command word may comprise at least one transmit/receive field. The transmit/receive field may comprise a bit indicating the direction of flow of data words between two RT devices on a shared data bus.

The command word may include a sub-address field. A sub-address field may be a remote terminal address. Additionally, a sub-address may identify a destination address within a specific remote terminal or subsystem. A specific remote terminal may have a multiplicity of addresses for different functions. So, for example, a sub-address may address a different sensor within a remote terminal. The message processor may extract the sub-address from the command word. When the extracted sub-address does not match the address of the RT to which the message is being transmitted, transmission of the message by second transceiver 130 is halted, thereby preventing an unauthorized RT from receiving the message in its entirety. With regards to MIL-STD-1553, the sub-address may be an address data buffer. The message processor 120 may be configured to obtain at least one determined destination address from an RT (e.g., RT 150). A determined destination address can be the value of an address for an RT. The RT (e.g., RT 150) may provide this address as a response to a request message, as part of an initialization procedure, through a broadcast message, combinations thereof, and/or the like. The message processor 120 may be configured to inhibit transmission by the RT (e.g., RT 150) when the determined destination address from the RT does not match the destination address. The message processor 120 may be configured to begin transmission of a command word even while extracting the destination address from the command word. As has been explained, this transmission may be stopped when it is determined that the RT to which the message is being transmitted is not an authorized or intended recipient.

According to some embodiments, message filter 110 may be constructed using, at least in part, commercial off the shelf (COTS) parts. For example, transceivers 130 and/or 140 may include MIL-STD-1553 transceiver chipset(s) and message processor 120 may be physical hardware that incorporates discrete or programmable analog, digital and/or quantum hardware. Examples of programmable hardware include: computers, microcontrollers, microprocessors, application-specific integrated circuits (ASICs); field-programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, the above mentioned technologies may be used in combination to achieve the desired result of a functional module.

While message processor 120 may be any number of different types of processors, there are advantages to be gained through using an FPGA, including the ability of the FPGA to process signals and data in real-time or near real-time. As will be described, the processing speed of FPGAs allows message transmission to be started and then halted if required while maintaining conformance with demanding timing standards, which can be important when used with certain communication protocols, such as MIL-STD-1553 and ARINC 629. As used herein, a FPGA is an integrated circuit designed to be configured after manufacturing. The FPGA configuration connects an array of programmable logic blocks. Programmable logic blocks of a FPGA may be configured to perform combinational functions and/or simpler logic gates like AND and/or XOR gates. Logic blocks may also include memory elements. The FPGA may be configured to decode MIL-STD-1553 bus signals and/or to control inputs/outputs of the bus transceiver chipset(s) (e.g., 140 and 130). As previously indicated, an FPGA may process signals in real-time or near real-time processing. Real-time processing may be employed to satisfy timing requirements in data bus specifications. For example, in accordance with the MIL-STD-1553 serial data bus standard, RT devices may start transmitting their response to a valid command within 4-12 microseconds and may be considered to not have received a command or message when no response has started within 14 microseconds. Some processors may not be suitable for use when they cannot meet the communication standards timing constraints because, for example, they need to acquire a whole message before decoding the message.

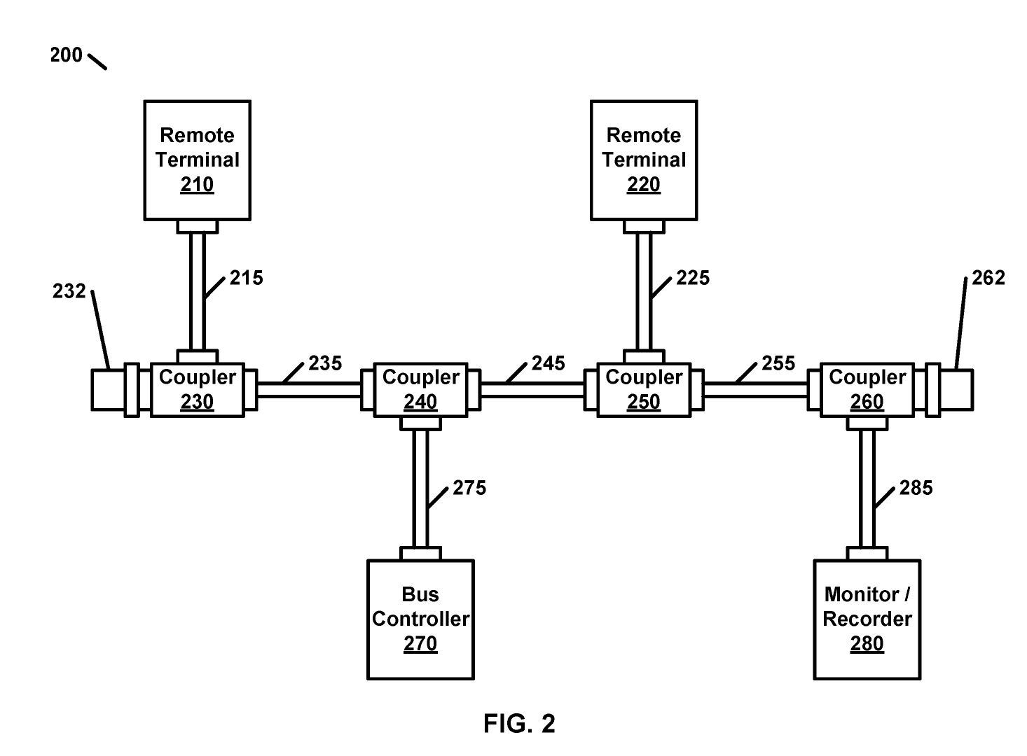

An example system architecture 200 that employs a MIL-STD-1553 bus is illustrated in FIG. 2Error! Reference source not found. MIL-STD-1553 bus may be wired as a shared data bus over which two or more RTs communicate. In accordance with the MIL-STD-1553 specification, the shared data bus is a redundant bus having first and second data busses. The shared data bus may communicate over links 235, 245 and 255 connected via couplers 240 and 250. This example architecture 200 has a single BC 270 which may solicit individual RTs (210 and 220) to transmit and/or receive data to and from the BC 270. BC 270 may be coupled to the shared data bus via link 275 and coupler 240. RT 210 may be coupled to the shared data bus via link 215 and coupler 230. RT 220 may be coupled to the shared data bus via link 225 and coupler 250. Also shown is a monitor/recorder 280 coupled to the shared data bus via link 285 and coupler 260. Coupler 260 may be terminated with cap 262. Coupler 230 may be terminated with cap 232. BC 270 may send commands addressed to specific RTs (e.g., RT 210 and/or RT 220). In systems which use MIL-STD-1553 for communications between BC 270, monitor/recorder 280, and RTs 210 and 220, bus traffic may be seen by all devices on the bus (e.g., 210, 270, 220, and 280) even though the traffic may only be addressed to one of the devices. This may be problematic if, for example, one of the RTs (e.g., 210 and 220) has embedded untested or unexercised code that could generate undesirable emissions on the shared data bus.

Embodiments of the present message filter may solve this problem. In accordance with various embodiments of the present disclosure, a message filter device may manage communications between a BC and a RT—such as BC 270 and RTs 210 and 220 in FIG. 2—partially decoding messages between the BC and the RT. The message filter may control the flow of traffic to and from the RT by, for example, manipulating a transceiver's RX enable and TX inhibit pins. When the message filter is awaiting BC messages, RTs may also be inhibited from transmitting onto the bus unless they are specifically requested to do so by the BC. For example, transmissions of the transceiver may be controlled by the message filter. If the ability of the filter transceiver to transmit is disabled and not re-enabled, messages from the filter transceiver will not make it onto the data bus.

According to some of the various embodiments, a message filter may have circuit board(s) with bus transceiver circuit(s) and message filter circuit(s). Bus transceiver circuit(s) may include, for example, a Holt IC 1553 transceiver (HI-2579CGTF) that converts a differential MIL-STD-1553 bus to two 0-3.3 volt digital signals for the message filter circuit. The transceiver chipset(s) may be configured to transmit and/or receive two MIL-STD-1553 busses simultaneously. Although the Holt IC transceiver is presented as an example circuit, other combination of MIL-STD-1553 transceivers from other vendors may be employed. The message filter circuit may be any of a suitable processor, such as a FPGA as previously mentioned. An example circuit is an Avnet Spartan-6 LX9 Microboard FPGA board. In other embodiments, the message filter circuit may include any one or more of a discrete logic circuit, an ASIC, a fast processor device, a combination of such circuits, or the like.

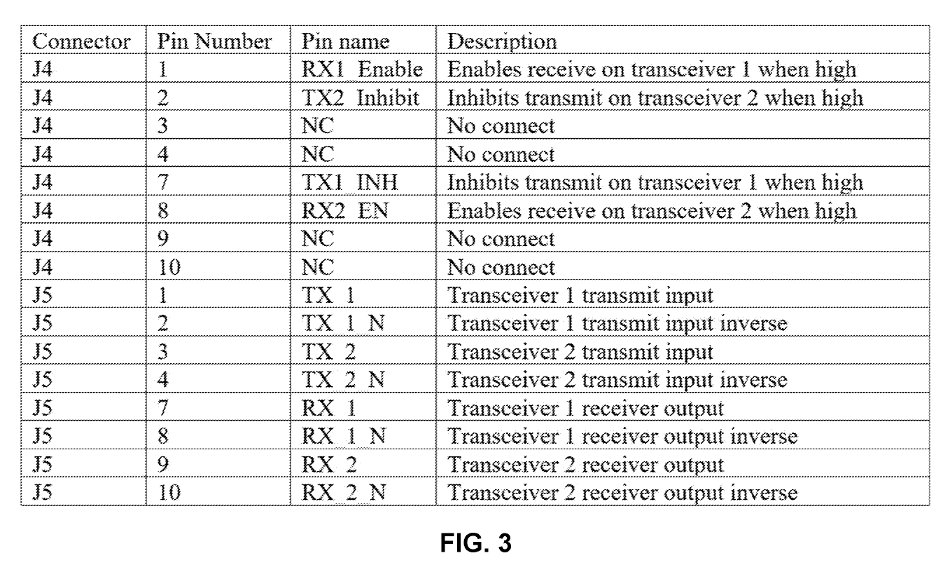

The bus transceiver circuit(s) may be configured to plug into a message filter circuit employing header connector(s). A FPGA on the example Spartan-6 FPGA board may be configured to capture digital representations of the MIL-STD-1553 signals, decode them in real-time or near real-time, and control the output of the transceivers. FIG. 3 is a table showing example pinouts for interfacing the example bus transceiver circuit(s) to the example Microboard FPGA development board. Although the Xilinx Spartan-6 FPGA is presented in this disclosure, other FPGA(s) from Xilinx or other vendors such as Altera™, Lattice Semiconductor™, or Microsemi™ may also be employed.

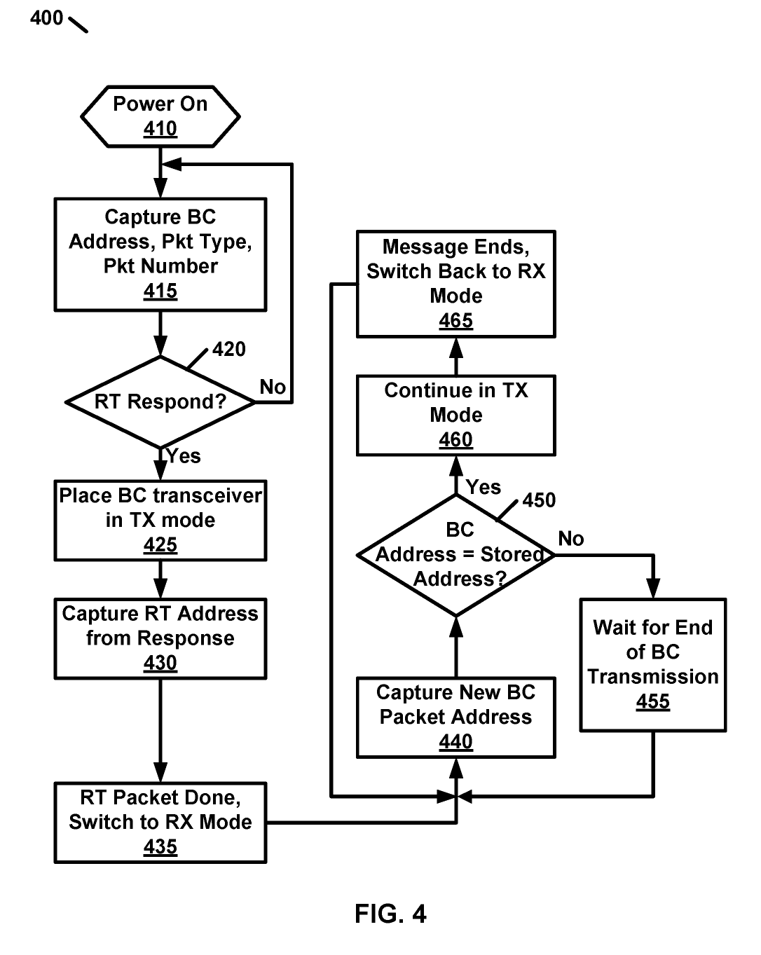

FIG. 4 is a flow diagram illustrating an example process 400, in accordance with an embodiment of the present disclosure. Process 400 can begin at 410 when power is first applied to the system. That system may include the message processor 120 of the filter device 110 illustrated in FIG. 1, which as previously discussed, may be configured to execute at least part of the process 400 and may include an FPGA. When power is first applied to the system at 410, a FPGA functioning as message processor 120 may be programmed by an on-board flash memory. Once programmed, the initial state FPGA may have no knowledge of RTs in the system. In this state, a first transceiver on the BC side of the filter may be placed in a constant RX mode and a second transceiver on the RT side of the filter may be placed in a constant TX mode.

Bus signals received by the FPGA from the BC may be decoded by a MIL-STD-1553 decoder module configured in the FPGA at 415. FIG. 5 is a diagram of an example message packet header of a packetized message, according to certain embodiments of the present disclosure. A MIL-STD-1553 message command word 500 has various fields, including three message synchronization (sync) bits in Sync field 510, five RT Address bits in field 520 may be decoded, followed by a receive/transmit bit in T/R field 530, five sub-address bits in Sub-Address field 540, five packet count bits in Packet Count field 550, and a parity bit in field 560. It is envisioned that other message formats may be employed within the scope of the presently claimed embodiments. All of these fields, 510, 520, 530, 550 and 560, except for the sub-address field 540, may be captured in on-chip memory of the FPGA for the remainder of the timing allowed by the communication protocol for message processing.

Referring again to FIG. 4, if the RT does not respond to the BC command message, as determined at 420, the message fields 510, 520, 530, 540, 550 and 560 stored in on-chip memory may be overwritten when the next BC command message arrives at 415. If the RT does respond, as determined at 420, the address bits, i.e. RT address bits in field 520 and/or sub-address bits in field 540, in the message may be captured and compared to the address from the BC. If the addresses match, the address may be permanently stored in FPGA storage until the device is reset or power cycled. The transceivers may be set so a BC transceiver is in TX mode and the RT transceiver is in the RX mode at 425. Once the RT has responded, the allowed RT's address may be stored in the FPGA at 430, thereby determining the destination address of an allowed RT device. This switched configuration may be enabled for the total number of packets to be transmitted per the packet count field. The decoder component in the FPGA may keep track of packet timing and switch the transceivers back to the original configuration at 435 when the final packet is transmitted.

New BC packet addresses may be captured at 440. The new BC addresses may be compared to the RT address bits in field 420 and/or Sub-address bits in field 540 as the bits flow sequentially through the process at 450. In the exemplary system 100, the message flow through the device 110 can be continuous by allowing bits to flow this way. If the new BC message contains an address for the RT, the transmission may continue at 460. If the new BC message contains an address that is not for the RT, the RT transmit pin may be inhibited and the process may wait for the end of the BC transmission at 455. By doing this, the RT may not be able to demodulate the partial message nor may the RT see the remaining information in that message. This function may allow the RT to only see messages addressed for it, and to keep the rest of the bus (other RTs) from seeing any traffic the RT might generate when it is not supposed to. When the message ends, the BC transceiver may be switched back into an RX mode at 465 until another BC packet address may be captured at 440.

According to some of the various embodiments, the selection of message processor hardware may need to consider response time capabilities with respect to the filtering of MIL-STD-1553 signals. When the BC sends a message to an RT, the BC may expect a response with a minimum time of 3 microseconds and a maximum of 12 microseconds. However, a decision to filter or pass the message may need to wait until all the bits on the RT address have been decoded. This amount of message time (as illustrated in example FIG. 5) is approximately 8 microseconds (three bits for the sync plus five bits for the address, each bit having a duration of 1 microsecond). The minimum return time for the RT's response may be 3 microseconds because the RT takes time to process the message from the BC. Therefore, if a processor is monitoring the bus or holding the packet before forwarding it to the RT, the minimum amount of time before the RT's response is received by the BC may be 11 microseconds (8 microseconds plus 3 microseconds). This may be within desired performance parameters, but may not leave enough time if an RT is lagging in response time. The RT's response may need to be timely to keep the MIL-STD-1553 system operating within the specification. Some designs that use a slower processor may have to buffer the entire packet before demodulating the message, identifying the RT address and forwarding the message to the RT. For this reason, the FPGA is one of the possible options to accomplish this task. The FPGA performs real-time analysis so that a decision can be made near-instantaneously on reception of the final address bit (8 microseconds), and not the final message bit (19 microseconds).

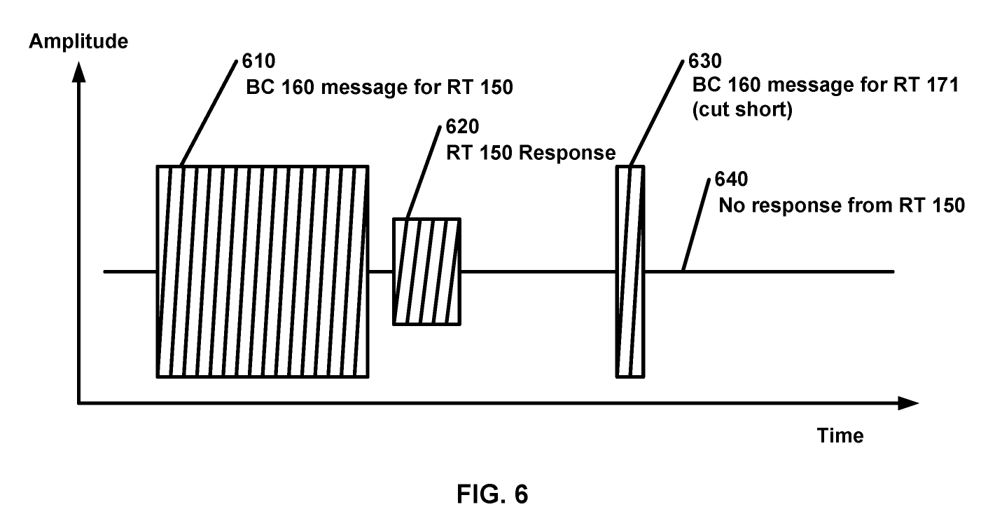

FIG. 6 is an example plot of a signal(s) being passed on the shared data bus 162 of system 100. As shown in the example plot, BC 160 is attempting to communicate with two RT units, RT 150 and RT 171. The timing may still be tight with respect to communication requirements specific to MIL-STD-1553 communications, in this particular example. This is why the message processor 120 may be configured to allow bits to flow through the message filter 110 to the intended RT before fully decoding the message. A BC 160 may send a message 610 addressed to RT 150. RT 150 may receive this message and generate a response 620 back to BC 160. If, however, BC 160 sends a message 630 to another RT (e.g., RT 171), the message processor 120 may determine that the message 630 is not meant for RT 150 on the other side of the filter. The message processor 120 may then truncate message 630 within 8 microseconds by stopping transmission of the message via transceiver 130. In this scenario, RT 150 will only receive a partial message (as seen as 640) and, as such, will not respond. As illustrated, the BC 160 may send a message 610 addressed to RT 150 via bus 152. This message is passed to RT 150 and RT 150 is allowed to pass a valid response 620 back to BC 160 by message processor 120. Next, the BC 160 tries to send a message to RT 171. The message processor 120 truncates this message before completing transmission to RT 150 and the partial message may be discarded. Because RT 150 never receives a valid message, RT 150 never generates a valid response back to BC 160 (shown as 640).

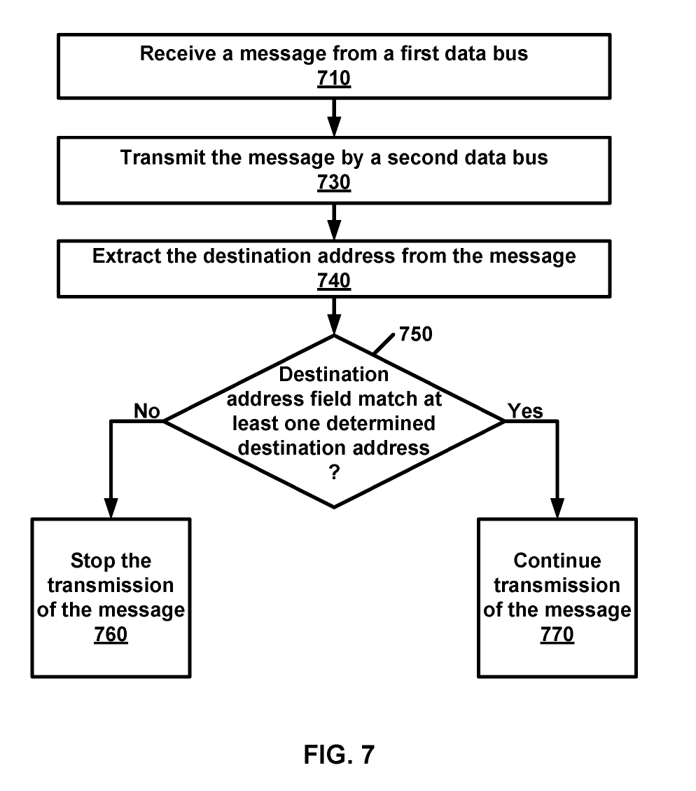

FIG. 7 is an example flow diagram, in accordance with an embodiment of the present disclosure. As illustrated in the drawing, a message may be received from a first data bus at 710. According to an embodiment, the message has a plurality of bits. Each of the plurality of bits may have a duration of approximately 1 microsecond. The message may include a command word. As described previously in connection with FIG. 5, the message command word may follow at least three synchronization bits, shown as field 510. The command word may further have at least one of a parity field 560 and a transmit/receive field 530. The command word may further include a sub-address field 540. The sub-address in the sub-address field 540 may be extracted from the command word. The sub-address field may include a remote terminal address, as previously noted in connection with the description of FIG. 5.

Transmission of the message on a second data bus may be started at 730. According to an embodiment, at least one of the first data bus and the second data bus may be a MIL-STD-1553 data bus. According to an embodiment, at least one of the first data bus and the second data bus may employ differential signaling.

A destination address, an address of a RT for which a message is intended, may be extracted from the command word at 740. According to an embodiment, transmission of the command word may begin while the destination address is extracted from the command word. The transmission of the message may be stopped at 760 when the destination address does not match at least one determined destination address (determined at 750) from the remote terminal (RT). The transmission of the message by the second transceiver, such as transceiver 130 of filter device 110 shown in FIG. 1, may be stopped when the sub-address does not match at least one determined sub-address. Otherwise, transmission of the message may continue at 770 if the destination address was determined at 750 to match the at least one determined destination address.

According to an embodiment, at least one of the first data bus and second data bus may be configured to electrically connect to a remote terminal. Transmission by the remote terminal may be inhibited when the determined destination address received from the remote terminal does not match the RT destination address.

The term “configured” or the like may relate to the capacity of a device whether the device is in an operational or non-operational state. Configured may also refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics in the device, whether the device is in an operational or non-operational state.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) employing using a FPGA to filter data on a MIL-STD-1553 shared data bus. However, one skilled in the art will recognize that embodiments of the disclosure may employ message processor devices other than FPGAs (for example, discrete logic, ASICs, fast processor devices, and/or combinations thereof) to analyze messages on other types of data busses (such as shared data busses employing MIL-STD-1773, RS 422, RS 485, and/or ARINC 629 busses).

1. A device comprising:
a first transceiver electrically coupled to a first data bus;
a second transceiver electrically coupled to a second data bus; and
a message processor configured to:
receive from the first transceiver a message on the first data bus, the message comprising a command word;
begin transmission of the message by the second transceiver on the second data bus;
extract a destination address of the message from the command word during transmission of the message by the second transceiver; and
stop the transmission of the message by the second transceiver when the destination address does not match at least one determined destination address, where the message is only partially transmitted by the second transceiver when the destination address does not match the at least one determined destination address.

2. The device according to claim 0, where at least one of the first data bus and the second data bus is a MIL-STD-1553 data bus.

3. The device according to claim 0, where at least one of the first data bus and the second data bus employs differential signaling.

4. The device according to claim 0, where the command word further comprises a sub-address field.

5. The device according to claim 4, where the sub-address field comprises a remote terminal address.

6. The device according to claim 4, where the message processor is further configured to:
extract the sub-address from the command word; and
stop the transmission of the message by the second transceiver when the sub-address does not match at least one determined sub-address.

7. The device according to claim 0, where the second data bus is configured to electrically couple to a remote terminal.

8. The device according to claim 7, where the message processor is further configured to obtain the at least one determined destination address from the remote terminal.

9. The device according to claim 7, where the message processor is further configured to inhibit transmission by the remote terminal when the at least one determined destination address from the remote terminal does not match the destination address.

10. The device according to claim 1, where the message processor is further configured to begin transmission of the command word while extracting the destination address from the command word.

11. The device according to claim 1, where the message processor is configured to extract the destination address after starting transmission of the message by the second transceiver.

12. The device according to claim 1, the message processor further configured to discard the partially transmitted message.

13-21. (canceled)

22. A system comprising:
a bus controller;
a remote terminal; and
a message filter comprising:
a first transceiver electrically coupled to the bus controller by a first data bus;
a second transceiver electrically coupled to the remote terminal by a second data bus; and
a message processor configured to:
receive from the first transceiver a message from the bus controller, the message comprising a command word;
begin transmission of the message by the second transceiver to the remote terminal;
extract a destination address from the command word during transmission of the message by the second transceiver; and
stop the transmission of the message when the destination address does not match at least one determined destination address, where the message is only partially transmitted by the second transceiver when the destination address does not match the at least one determined destination address.

23. The system according to claim 22, where at least one of the first data bus and the second data bus is a MIL-STD-1553 data bus.

24. The system according to claim 22, where the message processor is further configured to inhibit transmission by the remote terminal when the at least one determined destination address from the remote terminal does not match the destination address.

25. The system according to claim 22, where the message processor is further configured to begin transmission of the command word while extracting the destination address from the command word.

26. The system according to claim 22, the message processor configured to extract the destination address after starting transmission of the message by the second transceiver.

27. The system according to claim 22, the message processor further configured to inhibit transmission by the remote terminal on the second data bus unless the remote terminal is requested to transmit by the bus controller.

28. The system according to claim 22, the message processor further configured to discard the partially transmitted message.

29. The system according to claim 22, where the remote terminal cannot decode the partially transmitted message.
